(19) United States
(12) Patent Application Publication
(10) Pub. No.: US 2025/0370193 A1
(43) Pub. Date: Dec. 4, 2025

(54) STRUCTURAL COMPONENT FOR ENABLING OPTIMAL COUPLING OF A CONNECTOR OF A FIBER DEVICE AND A CONNECTOR OF AN ADAPTER COMPONENT OF A FIBER INSPECTION DEVICE

(71) Applicant: VIAVI Solutions Inc., Chandler, AZ (US)

(72) Inventors: Kevin CASSADY, Monroe, WA (US); Robert Matthew ADAMS, Ottawa (CA)

(21) Appl. No.: 18/680,610

(22) Filed: May 31, 2024

(51) Int. Cl. G02B 6/38; G01M 11/00

(52) U.S. Cl. CPC G02B 6/385; G01M 11/31; G02B 6/3825

(57) ABSTRACT

A structural component includes a mounting element configured to mount the structural component to an adapter component of a fiber inspection device; a first engagement part of a first holding element that is configured to contact a first surface of a fiber device; and a second engagement part of a second holding element that is configured to contact a second surface of the fiber device. The first engagement part and the second engagement part are further configured to receive the fiber device in a particular orientation to cause the first engagement part to contact the first surface of the fiber device and the second engagement part to contact the second surface of the fiber device, and hold the fiber device in a particular position and in the particular orientation. Accordingly, the structural component enables coupling of a connector of the fiber device and a connector of the adapter component.

### BACKGROUND

Optical communications systems may be deployed to provide high-speed communications between compute nodes of a computing system. For example, computing systems used for artificial intelligence (AI) and machine learning (ML) applications may use optical communications systems to communicate large amounts of data at high speeds. Such optical communications systems may include optical transceivers that transmit and receive data to other optical transceivers via optical fibers. The optical fibers may be provided in an optical fiber array and use Institute of Electrical and Electronics Engineers (IEEE) 802.3 formats, such as a direct attach (DR) type or a short reach (SR) type. An optical fiber array may include a fiber array connector, which enables multiple optical fibers to be coupled to an input or output port of an optical transceiver.

### SUMMARY

In some implementations, a structural component includes a mounting element configured to mount the structural component to an adapter component of a fiber inspection device; a first holding element and a second holding element connected to the mounting element; a first engagement part of the first holding element that is configured to contact a first surface of a fiber device; and a second engagement part of the second holding element that is configured to contact a second surface of the fiber device, wherein: the first engagement part and the second engagement part are further configured to: receive the fiber device in a particular orientation to cause the first engagement part to contact the first surface of the fiber device and the second engagement part to contact the second surface of the fiber device, and hold the fiber device in a particular position and in the particular orientation.

In some implementations, a fiber inspection device includes an adapter component; and a structural component that includes: a mounting element that mounts the structural component on the adapter component; a first holding element and a second holding element connected to the mounting element; a first engagement part positioned on the first holding element that is configured to contact a first surface of a fiber device; and a second engagement part positioned on the second holding element that is configured to contact a second surface of the fiber device, wherein: the first engagement part and the second engagement part are further configured to: receive the fiber device in a particular orientation to cause the first engagement part to contact the first surface of the fiber device and the second engagement part to contact the second surface of the fiber device, and hold the fiber device in a particular position and in the particular orientation.

In some implementations, a structural component includes a first engagement part of a first holding element that is configured to contact a first surface of a fiber device; and a second engagement part of a second holding element that is configured to contact a second surface of the fiber device, wherein: the first engagement part and the second engagement part are further configured to: receive the fiber device in a particular orientation to cause the first engagement part to contact the first surface of the fiber device and the second engagement part to contact the second surface of the fiber device, and hold the fiber device in a particular position and in the particular orientation.

### BRIEF DESCRIPTION OF THE DRAWINGS

FIGS. 1A-1D are diagrams of an example implementation associated with a structural component for enabling optimal coupling of a connector of a fiber device and a connector of an adapter component of a fiber inspection device.

FIGS. 2A-2D are diagrams of an example implementation associated with a structural component for enabling optimal coupling of a connector of a fiber device and a connector of an adapter component of a fiber inspection device.

FIGS. 3A-3D are diagrams of an example implementation associated with a structural component for enabling optimal coupling of a connector of a fiber device and a connector of an adapter component of a fiber inspection device.

### DETAILED DESCRIPTION

The following detailed description of example implementations refers to the accompanying drawings. The same reference numbers in different drawings may identify the same or similar elements. The following description uses a microscopy as an example. However, the techniques, principles, procedures, and methods described herein may be used with any sensor, including but not limited to other optical sensors and microscopic sensors.

Different formats of optical fiber arrays and optical connectors may be used in optical communications systems, such as the DR4 and DR8 optical module physical layer formats. Data centers or cloud computing environments, among other examples, may use optical communications systems for high-speed data transmission, which may be used in artificial intelligence (AI) or machine learning (ML) applications. The DR4 format may utilize an optical fiber array with 4 parallel lanes or channels for data transmission, which may achieve a 400 Gigabit (Gb) link when each lane is configured for a 100 Gb signal. Similarly, the DR8 format may utilize an optical fiber array with 8 parallel lanes for data transmission, which may achieve an 800 Gb link when each lane is configured for a 100 Gb signal.

An optical transceiver can include a connector that comprises an optical fiber array. The connector may be, for example, a multi-fiber push-on (MPO) connector (e.g., for coupling DR4 format optical fiber arrays or DR8 format optical fiber arrays). Although some examples are described herein in terms of an MPO connector, it is contemplated that implementations described herein may apply to other types of connectors. To achieve high levels of data transmission without introducing errors, an optical fiber array and associated connector may be inspected to ensure there are no manufacturing defects or environmental damage that may affect performance. For example, a fiber inspection device may image an optical fiber array and connector to determine whether a defect is detected in the optical fiber array and connector. The fiber inspection device may detect a presence of dirt, oil, pitting, or scratching, among other examples, which may negatively affect performance of an MPO connector used for an optical fiber array.

In some cases, the fiber inspection device includes an adapter component that includes a connector that is to couple to the connector of the optical transceiver to allow for inspection of the optical fiber array. Often, however, the optical transceiver includes a latch component, or another type of manual interaction component, that impedes access to the connector of the optical transceiver. This makes coupling of the connector of the optical transceiver to the connector of the adapter component difficult and time intensive. Further, the optical transceiver needs to remain steadily in place on the connector of the adapter component while the fiber inspection device performs an inspection. Any excess movement reduces an accuracy of the inspection, which can result in an optical transceiver falsely being identified as dirty or damaged, and therefore additional, unnecessary testing of the optical transceiver is often needed. This, in turn, results in unnecessary consumption of computing resources (e.g., processing resources, memory resources, communication resources, and/or power resources, among other examples) of the fiber inspection device (or another fiber inspection device) to re-inspect the optical transceiver.

Some implementations described herein include a structural component. The structural component includes a mounting element that is configured to mount the structural component to an adapter component of a fiber inspection device (e.g., around a portion of the adapter component). The structural component includes a first holding element and a second element that are connected to the mounting element. A first engagement part of the first holding element is configured to contact a first surface of a fiber device (e.g., an optical transceiver, or another device that includes one or more optical fibers) and a second engagement part of the second holding element is configured to contact a second surface of the fiber device. In some implementations, a third engagement part of the mounting element is configured to contact a third surface of the fiber device.

Accordingly, the first engagement part, the second engagement part, and/or the third engagement part are configured to receive the fiber device in a particular orientation (e.g., to cause the first engagement part to contact the first surface of the fiber device, the second engagement part to contact the second surface of the fiber device, and/or the third engagement part to contact the third surface of the fiber device). The particular orientation of the fiber device enables a connector of the fiber device to align with a connector of the adapter component of the fiber inspection device. Additionally, the first engagement part, the second engagement part, and/or the third engagement part are configured to hold the fiber device in a particular position and in the particular orientation. The particular position of the fiber device enables the connector of the fiber device to contact the second connector of the adapter component of the fiber inspection device. Therefore, based on receiving the fiber device and holding the fiber device in the particular position and the particular orientation, the first engagement part, the second engagement part, and/or the third engagement part are configured to enable coupling of the connector of the fiber device and the connector of the adapter component of the fiber inspection device.

In this way, the structural component facilitates orientating and positioning of the fiber device in an optimal orientation and in an optimal position to allow for an optimal coupling of the connector of the fiber device and the connector of the adapter component of the fiber inspection device (e.g., even when the fiber device includes a latch component, or other component, that impedes access to the connector of the fiber device). In this way, the structural component increases a likelihood that the fiber inspection device is able to accurately inspect (e.g., using microscopy) the fiber device. Further, the structural component enables stable orientation and positioning of the fiber device during inspection by the fiber inspection device, which decreases a likelihood of false negative inspections by the fiber inspection device. This therefore decreases a number of unnecessary re-inspections of the fiber device that would otherwise be performed, and therefore reduces consumption of computing resources (e.g., processing resources, memory resources, communication resources, and/or power resources, among other examples) of the fiber inspection (or another fiber inspection device) that would otherwise be consumed to re-inspect the fiber device.

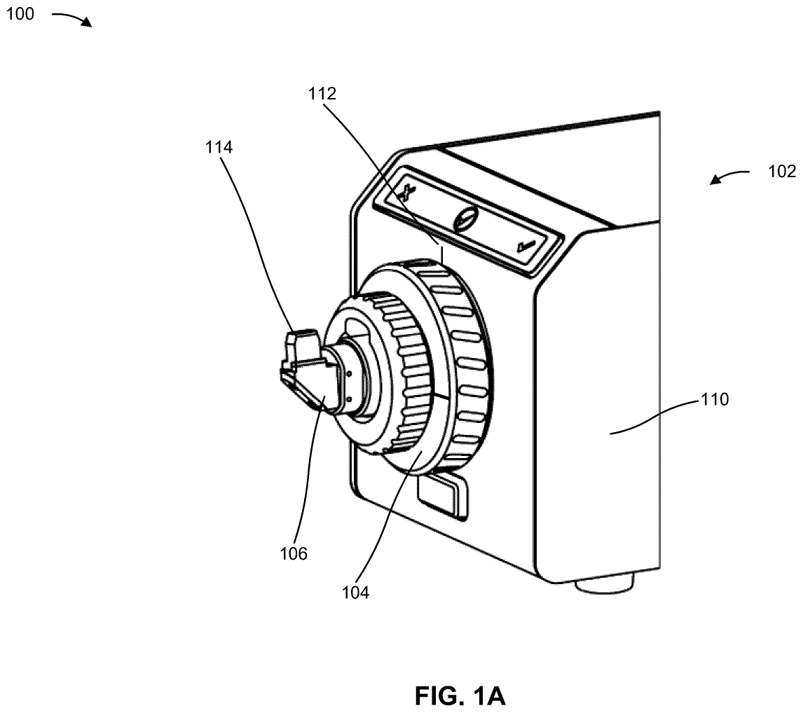

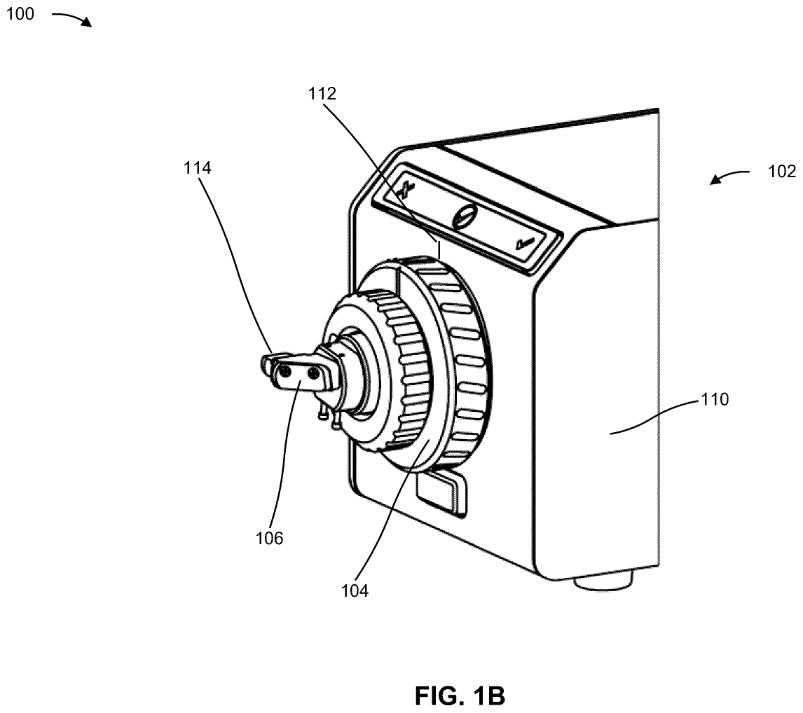

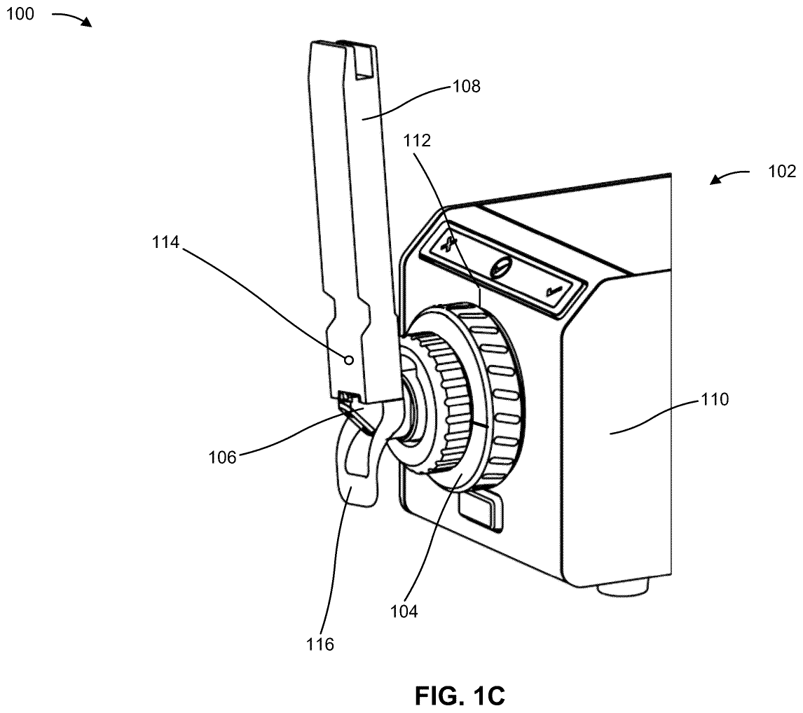

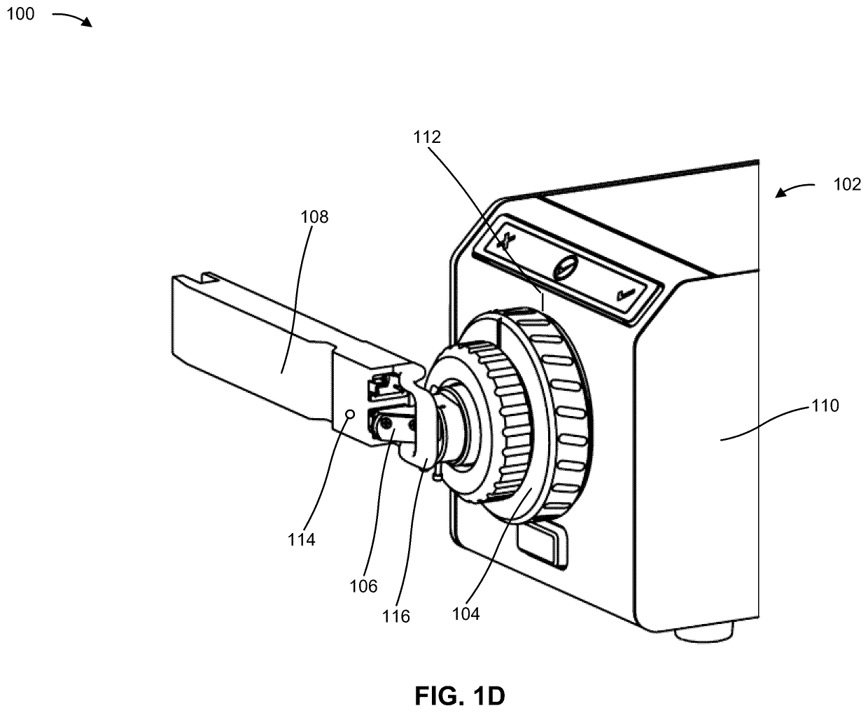

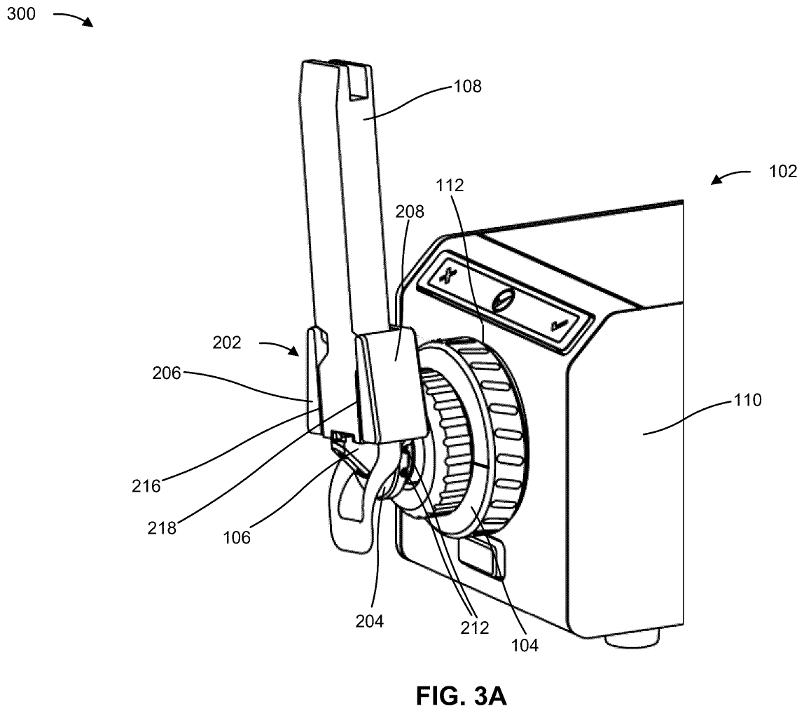

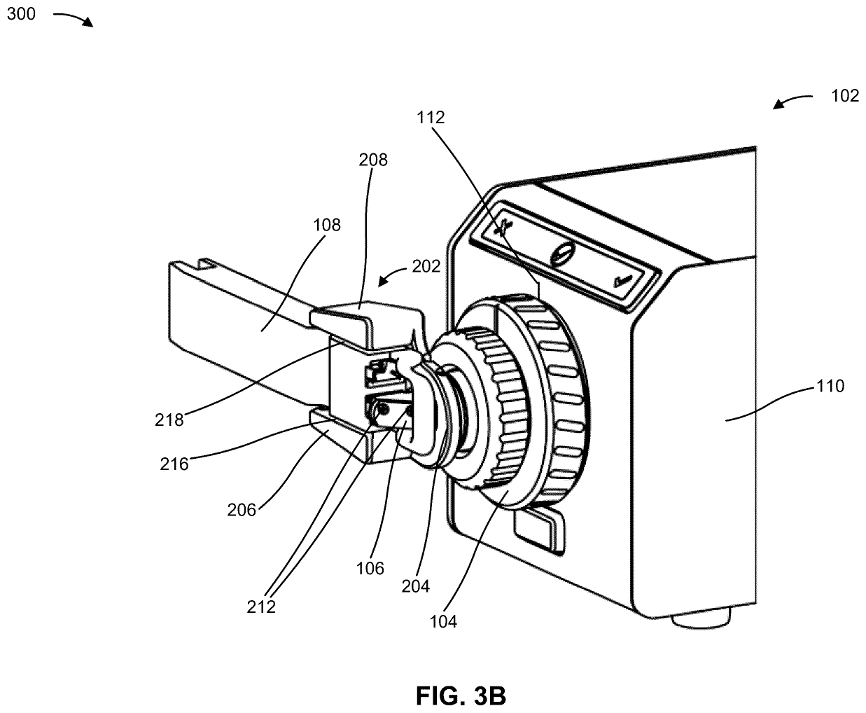

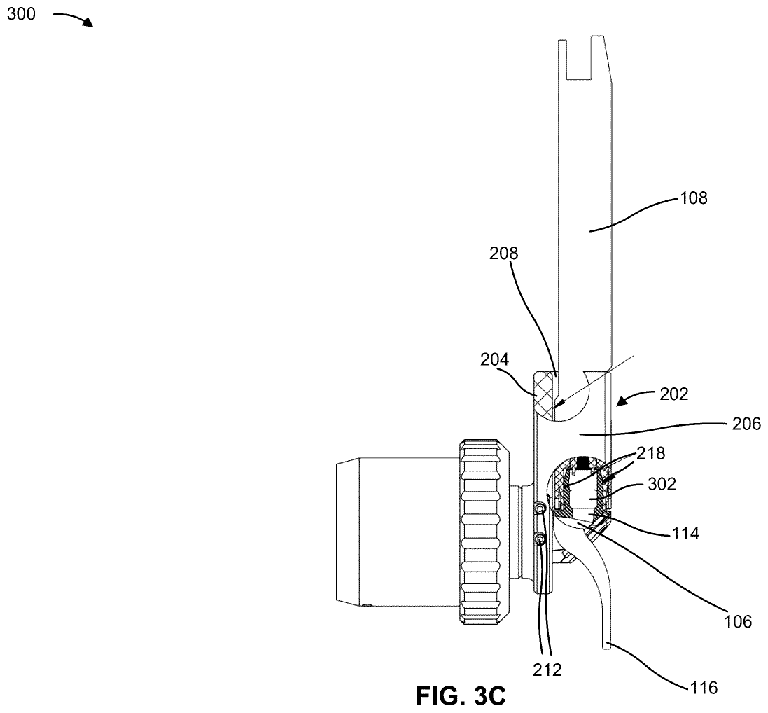

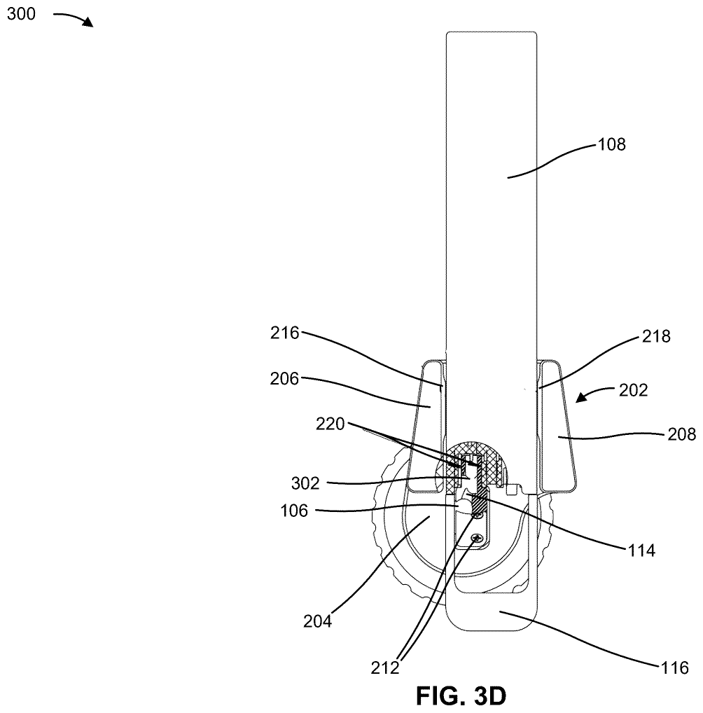

FIGS. 1A-1D are diagrams of an example implementation 100 associated with a structural component for enabling optimal coupling of a connector of a fiber device and a connector of an adapter component of a fiber inspection device. As shown in FIGS. 1A-1D, example implementation 100 comprises a fiber inspection device 102 that includes an adjustment component 104 and an adapter component 106. The fiber inspection device 102 may be configured to inspect (e.g., optically inspect) a fiber device 108 (shown in FIGS. 1C-1D). In some implementations, the fiber device 108, which may also be referred to as a “device under test” or “DUT,” may include a connector (e.g., that includes one or more optical fibers). For example, the fiber device 108 may include an MPO type connector or other array connector (shown in FIGS. 3C-3D as connector 302).

The fiber inspection device 102 may include (e.g., within a housing 110 of the fiber inspection device 102) a sensor device (e.g., microscopic sensor device, a microscope assembly, an opto-mechanical assembly, or a sensor element) to perform an inspection (e.g., an optical inspection, such as using microscopy) of the fiber device 108. In this way, the fiber inspection device 102 may be configured to inspect a set of optical fibers, channels, or other physical elements of the fiber device 108.

The adjustment component 104 may be configured to turn, such as a result of a manual turning (e.g., hand turning) or an electrical turning (e.g., turning based on electrical signal or computer-based control). In some implementations, the adjustment component 104 may be disposed at least partially within an opening of the housing 110 of the fiber inspection device 102. For example, the adjustment component 104 may be inserted into the opening of the housing 110 of the fiber inspection device 102. In this case, an outer surface of the adjustment component 104 may be disposed within the opening of the housing 110 of the fiber inspection device 102, and an inner surface of the adjustment component 104 may be shaped to receive and to hold the adapter component 106.

In some implementations, the adjustment component 104 may be associated with a set of indicia. For example, the adjustment component 104, or the housing 110 of the fiber inspection device 102, may include an indicium to indicate a configured position for the adjustment component 104. For example, as shown in FIGS. 1A-1D, and by reference number 112, a visual indicium may be provided in connection with the adjustment component 104. In this case, the visual indicium may be disposed on the adjustment component 104, on the housing 110, or on another component. In some implementations, multiple indicia may be present to indicate multiple configured positions for the adjustment component 104. In some implementations, a tactile indicium may be provided in connection with the adjustment component 104. For example, the adjustment component 104 may have a detent (e.g., a mechanical detent, a magnetic detent, or another type of detent), such that a user, when turning the adjustment component 104, can feel when a configured position or desired orientation is reached. Similarly, when the adjustment component 104 is a computer-controlled electrical adjustment component, a detent may be present on or in connection with the adjustment component 104 to divide rotation of the adjustment component 104 into discrete increments corresponding to configured positions.

In some implementations, the adapter component 106 may include a connector 114 that is configured to couple to a connector of the fiber device 108 (e.g., the connector 302 of the fiber device 108 described herein in relation to FIGS. 3C-3D). In this way, the adapter component 106 is configured to couple the fiber device 108 to the fiber inspection device 102 (e.g., to the sensor device of the fiber inspection device 102, such as to enable inspection of the fiber device 108). For example, as shown in FIGS. 1C-1D, the fiber device 108 may couple to the fiber inspection device 102 by being oriented and positioned such that the connector of the fiber device 108 couples to the connector 114 of the adapter component 106.

In some implementations, the adapter component 106 may include a reflective optic (e.g., a mirror or another type of reflective optic) that reflects light to and/or from the connector of the fiber device 108 to enable the sensor device of the fiber inspection device 102 to inspect a set of optical fibers, channels, or other physical elements associated with the connector of the fiber device 108. In this way, rather than a latch component 116 of the fiber device 108 (that is positioned at an end of the fiber device 108 associated with the connector of the fiber device 108) being inserted into an opening, socket, or end of the fiber inspection device 102 (e.g., to allow for inspection of the connector of the fiber device 108), the adapter component 106 allows the fiber device 108 to be positioned external to the fiber inspection device 102.

In some implementations, the adjustment component 104 may be configured to rotate the adapter component 106. For example, because the adjustment component 104 holds the adapter component 106, when the adjustment component 104 is rotated (e.g., as a result of manual turning or electrical turning), the adapter component 106 rotates. Accordingly, the adjustment component 104 may be configured to rotate the adapter component 106 to adjust an orientation of the adapter component 106, such as to a “vertical” orientation shown in FIG. 1A or a “horizontal” orientation shown in FIG. 1B. Accordingly, the fiber device 108, to allow a connector of the fiber device 108 to couple to the connector 114 of the adapter component 106, is to have a same, or similar, orientation of the adapter component 106. For example, as shown in FIG. 1C, the fiber device 108 is to have a vertical orientation when the adapter component 106 has a vertical orientation, or, as shown in FIG. 1D, the fiber device 108 is to have a horizontal orientation when the adapter component 106 has a horizontal orientation. Preferred orientations of the adapter component 106 and the fiber device 108 (e.g., to enable coupling of the fiber device to the fiber inspection device 102) may depend on a physical design of the fiber device 108 (e.g., in terms of a three-dimensional footprint of the fiber device 108). Accordingly, the adjustment component 104 may be configured to rotate to multiple different positions to enable rotation of the adapter component 106 to many different orientations to facilitate selection of a particular orientation for a particular fiber device 108 with a particular physical design.

As indicated above, FIGS. 1A-1D are provided as an example. Other examples may differ from what is described with regard to FIGS. 1A-1D.

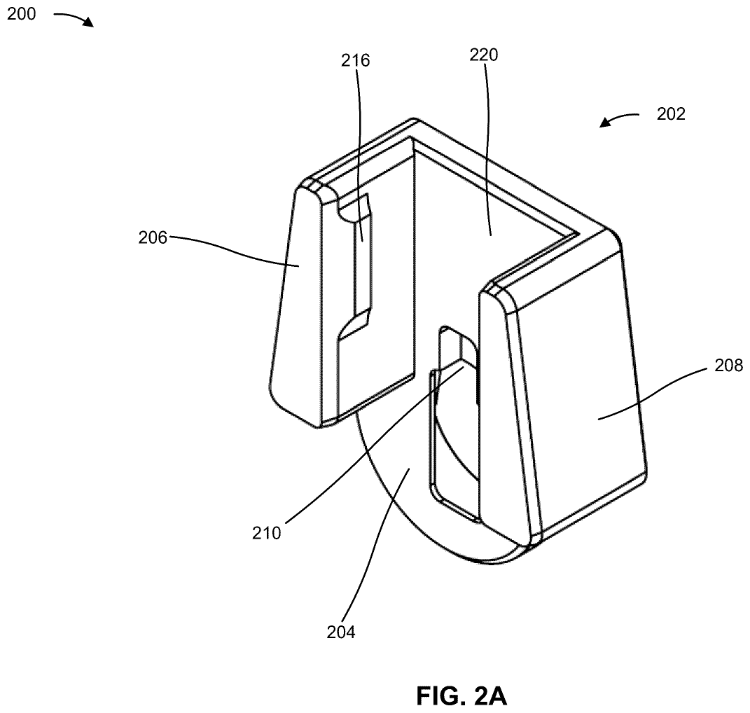

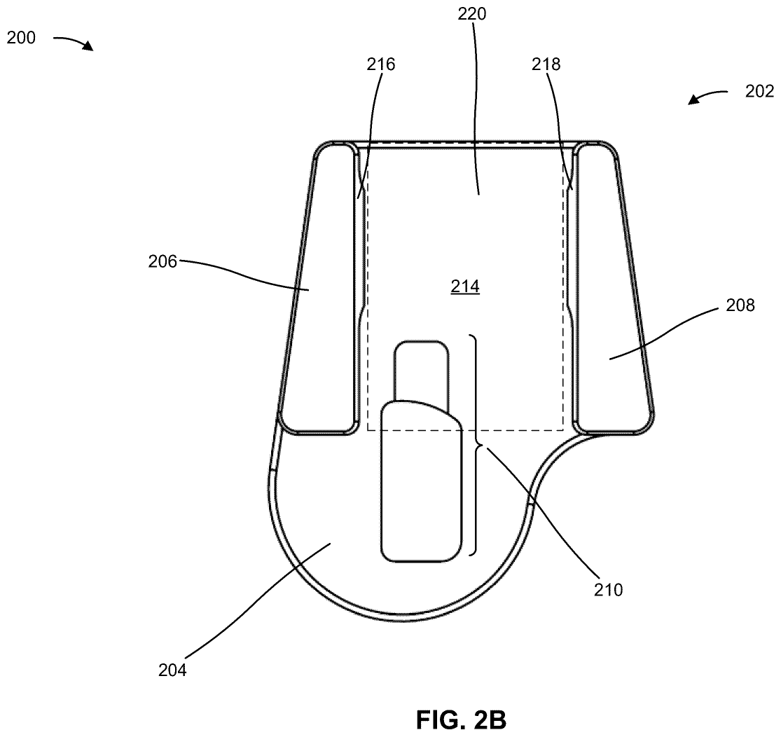

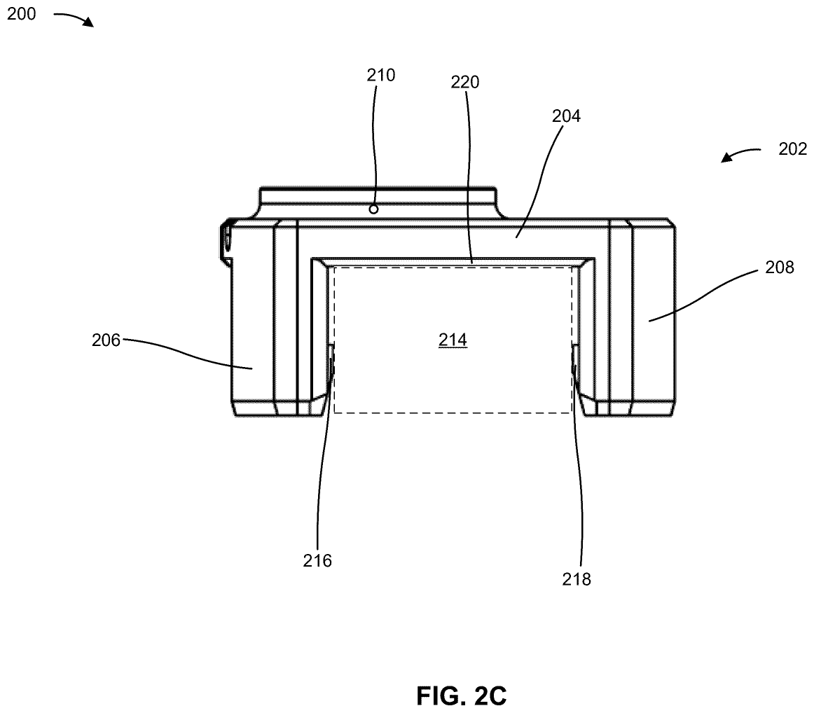

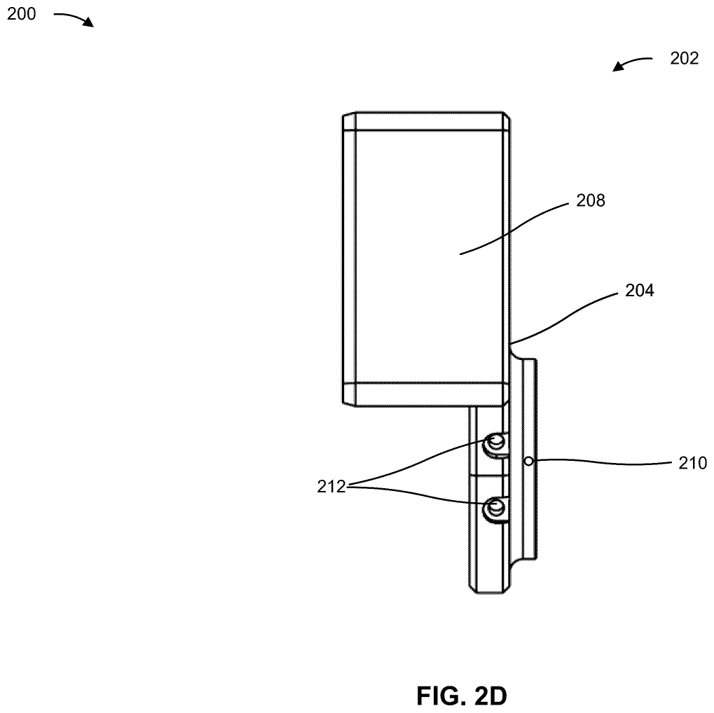

FIGS. 2A-2D are diagrams of an example implementation 200 associated with a structural component for enabling optimal coupling of a connector of a fiber device and a connector of an adapter component of a fiber inspection device. As shown in FIGS. 2A-2D, example implementation 200 comprises a structural component 202, which includes a mounting element 204, a first holding element 206, and/or a second holding element 208. The structural component 202 may be configured to receive and hold the fiber device 108, as further described herein. FIG. 2A shows an angled front-view of the structural component 202, FIG. 2B shows a front-view of the structural component 202, FIG. 2C shows a top-down view of the structural component 202, and FIG. 2D shows a side view of the structural component 202 (e.g., a view of a right side of the structural component 202 shown in FIGS. 2A-2C).

The mounting element 204 may be configured to mount the structural component 202 to the fiber inspection device 102, such as to the adapter component 106 of the fiber inspection device 102. For example, as shown in FIGS. 2A-2C, the mounting element 204 may include a mounting feature 210 (e.g., a hole, a pass-through, an aperture, or a similar type of feature) that is configured to at least partially surround a portion (e.g., a circumferential region) of the adapter component 106 of the fiber inspection device 102. The mounting feature 210 may be shaped and/or sized to allow the connector 114 of the adapter component to insert into and to pass through mounting feature 210 (e.g., as part of a process to mount the mounting element 204 to the fiber inspection device 102), such as to allow the connector 114 to insert into and to pass through the mounting feature 210 without the connector 114 contacting any portion of the mounting feature 210 (e.g., an edge of the mounting feature 210). As shown in FIG. 2D, the mounting element 204 may include one or more stability parts 212 (e.g., one or more set screws or other types of fasteners) that are configured to secure the mounting feature 210 in a position (e.g., in a position that at least partially surrounds the portion of the adapter component 106 of the fiber device 108). In some implementations, the mounting feature 210 may resemble a collar that is positioned such that the mounting feature 210 surrounds a portion of the adapter component 106, and the one or more stability parts 212 may exert a force to secure the mounting feature 210 in the position.

The first holding element 206 and the second holding element 208 may be connected to the mounting element 204. Each of the first holding element 206 and the second holding element 208 may be a structural element that is configured to facilitate receiving of and holding of the fiber device 108, as further described herein. For example, as shown in FIGS. 2A-2D, the first holding element 206 and the second holding element 208 may be planar elements, and may have surfaces (e.g., internal facing surfaces) that are parallel to, or approximately parallel to (e.g., within a tolerance of 1 or 2 degrees), each other.

In some implementations, the mounting element 204, the first holding element 206, and the second holding element 208 may be a monolithic component (e.g., the mounting element 204, the first holding element 206, and the second holding element 208 are a contiguous component and do not use fasteners, adhesive, or other means to connect to each other). Accordingly, the structural component 202 may be a monolithic component itself. In some implementations, the mounting element 204, the first holding element 206, and the second holding element 208 may define a holding volume 214 of the structural component 202 (e.g., where surfaces of the mounting element 204, the first holding element 206, and the second holding element 208 physically define sides of the holding volume 214 and other sides of the holding volume 214 are implied by connecting imaginary lines among edges of the surfaces). The mounting element 204, the first holding element 206, and/or the second holding element 208 may be configured hold the fiber device 108 to cause a portion of the fiber device 108 to be located within the holding volume 214, as further described herein.

In some implementations, the first holding element 206 may include a first engagement part 216 and the second holding element 208 may include a second engagement part 218. Each engagement part may include, for example, a portion of a surface of the corresponding holding element and/or a ridge, a nub, a bump, a groove, a slot, a clip, a clasp, a suction cup, a magnet, a textured feature, a friction-increasing feature, and/or or another type of engagement part. For example, as shown in FIGS. 2A-2C, the first engagement part 216 may be a ridge positioned on the internal surface of the first holding element 206 and the second engagement part 218 maybe a ridge positioned on the internal surface of the second holding element 208. The first engagement part 216 may be configured to contact a first surface of the fiber device 108 and the second engagement part 218 may be configured to contact a second surface of the fiber device 108 (e.g., when receiving and holding the fiber device 108).

Accordingly, the first engagement part 216 and the second engagement part 218 may be further configured to receive the fiber device 108 in a particular orientation (e.g., to cause the first engagement part 216 to contact the first surface of the fiber device 108 and the second engagement part 218 to contact the second surface of the fiber device 108). That is, to receive the fiber device 108 such that the first engagement part 216 contacts the first surface of the fiber device 108 and the second engagement part 218 contacts the second surface of the fiber device 108, the fiber device 108 must be oriented in the particular orientation. The particular orientation of the fiber device 108 enables a connector (e.g., the connector 302 of the fiber device 108 described herein in relation to FIGS. 3C-3D) of the fiber device to align with the connector 114 of the adapter component 106 of the fiber inspection device 102. That is, the connectors are arranged such that corresponding parts of the connectors (e.g., that enable coupling of the connectors) are aligned with each other.

Additionally, the first engagement part 216 and the second engagement part 218 may be further configured to hold the fiber device 108 in a particular position (and in the particular orientation). The particular position of the fiber device 108 enables the connector of the fiber device 108 to contact the connector 114 of the adapter component 106 of the fiber inspection device 102. Accordingly, because the first engagement part 216 and the second engagement part 218 receive and hold the fiber device 108 in the particular orientation, holding the fiber device 108 in the particular position enables coupling of the connector of the fiber device 108 and the connector 114 of the adapter component 106 of the fiber inspection device 102. This thereby allows for the fiber inspection device 102 (e.g., using the sensor device of the fiber inspection device 102) to accurately inspect the fiber device 108 (e.g., by facilitating stable orientation and positioning of the fiber device 108 during inspection by the fiber inspection device 102).

In some implementations, the mounting element 204 may include a third engagement part 220, which may include, for example, a portion of a surface of the mounting element 204 and/or a ridge, a nub, a bump, a groove, a slot, a clip, a clasp, a suction cup, a magnet, a textured feature, a friction-increasing feature, and/or or another type of engagement part. For example, as shown in FIGS. 2A-2C, the third engagement part 220 may be a portion of an internal surface of the mounting element 204. The third engagement part 220 may be configured to contact a third surface of the fiber device 108 (e.g., when receiving and holding the fiber device 108). Accordingly, the third engagement part 220 may be further configured to receive the fiber device 108 in the particular orientation, and to hold the fiber device 108 in the particular position (and in the particular orientation) (e.g., to cause the third engagement part 220 to contact the third surface of the fiber device 108), such as in a similar matter as that described herein in relation to the first engagement part 216 and the second engagement part 218. The third engagement part 220 therefore enables coupling of the connector of the fiber device 108 and the connector 114 of the adapter component 106 of the fiber inspection device 102, which allows for the fiber inspection device 102 (e.g., using the sensor device of the fiber inspection device 102) to accurately inspect the fiber device 108 (e.g., by facilitating stable orientation and positioning of the fiber device 108 during inspection by the fiber inspection device 102).

In some implementations, the first engagement part 216, the second engagement part 218, and/or the third engagement part 220 are further configured to hold the fiber device 108 in the particular position and in the particular orientation to cause a portion of the fiber device 108 to be located within the holding volume 214 of the structural component 202. In this way, the first engagement part 216, the second engagement part 218, and/or the third engagement part 220 protect the fiber device 108 from being jostled or otherwise repositioned during inspection of the fiber device 108 by the fiber inspection device 102.

As indicated above, FIGS. 2A-2D are provided as an example. Other examples may differ from what is described with regard to FIGS. 2A-2D.

FIGS. 3A-3D are diagrams of an example implementation 300 associated with a structural component for enabling optimal coupling of a connector of a fiber device and a connector of an adapter component of a fiber inspection device. As shown in FIGS. 3A-3D, example implementation 300 comprises the fiber inspection device 102, which includes the adjustment component 104, the adapter component 106, and the structural component 202, as elsewhere described herein. That is, FIGS. 3A-3D show the structural component 202 mounted on the fiber inspection device 102 (e.g., as a component that is integrated into the fiber inspection device 102 or as a separate component that is attachable and removable from the fiber inspection device 102). FIG. 3A shows the structural component 202 holding the fiber device 108 in a first position and in a vertical orientation; FIG. 3B shows the structural component 202 holding the fiber device 108 in a second position and in a horizontal orientation; FIG. 3C shows a side view of the structural component 202 holding the fiber device 108 in the first position and in the vertical orientation, with transparent portions showing details of the adapter component 106, the fiber device 108, and the structural component 202; and FIG. 3D shows a front view of the structural component 202 holding the fiber device 108 in the first position and in the vertical orientation, with transparent portions showing details of the adapter component 106, the fiber device 108, and the structural component 202.

As shown in FIG. 3C, the mounting element 204 of the structural component 202 mounts the structural component 202 on the adapter component 106. For example, the mounting feature 210 of the mounting element 204 may be positioned to at least partially surround a portion of the adapter component 106, and the one or more stability parts 212 may secure the mounting feature 210 in the position.

As shown in FIGS. 3A-3D, the first engagement part 216 of the first holding element 206 contacts a first surface of the fiber device 108 and the second engagement part 218 of the second holding element 208 contacts a second surface of the fiber device 108. Further, the third engagement part 220 of the mounting element 204 contacts a third surface of the fiber device 108. In this way, the first engagement part 216, the second engagement part 218, and/or the third engagement part 220 cause the fiber device 108 to be held in a particular position and in a particular orientation.

For example, to allow the structural component 202 to receive the fiber device 108, as shown in FIGS. 3A and 3C-3D, the first engagement part 216, the second engagement part 218, and/or the third engagement part 220 may cause the fiber device to be oriented in a vertical orientation (e.g., to correspond to a vertical orientation of the of the adapter component 106). That is, because of a geometry provided by the first engagement part 216, the second engagement part 218, and/or the third engagement part 220, that define the holding volume 214, the fiber device 108 can only be inserted into the structural component 202 in a vertical orientation (e.g., to allow a portion of the fiber device 108 to be inserted into the holding volume 214). Further, the first engagement part 216, the second engagement part 218, and/or the third engagement part 220 may hold the fiber device 108 in the vertical orientation and in a particular position that allows a connector 302 (e.g., a ferrule or another type of connector) of the fiber device 108 to connect to the connector 114 of the adapter component 106 (e.g., as shown in FIGS. 3C-3D). This therefore enables coupling of the connector 302 and the connector 114 of the adapter component 106.

As indicated above, FIGS. 3A-3D are provided as an example. Other examples may differ from what is described with regard to FIGS. 3A-3D.

The foregoing disclosure provides illustration and description, but is not intended to be exhaustive or to limit the implementations to the precise forms disclosed. Modifications and variations may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”). Further, spatially relative terms, such as “below,” “lower,” “bottom,” “above,” “upper,” “top,” and the like, may be used herein for ease of description to describe one element or feature's relationship to another element(s) or feature(s) as illustrated in the figures. The spatially relative terms are intended to encompass different orientations of the apparatus, device, and/or element in use or operation in addition to the orientation depicted in the figures. The apparatus may be otherwise oriented (rotated 90 degrees or at other orientations) and the spatially relative descriptors used herein may likewise be interpreted accordingly.

What is claimed is:

1. A structural component, comprising:
a mounting element configured to mount the structural component to an adapter component of a fiber inspection device;
a first holding element and a second holding element connected to the mounting element;
a first engagement part of the first holding element that is configured to contact a first surface of a fiber device; and
a second engagement part of the second holding element that is configured to contact a second surface of the fiber device, wherein:
the first engagement part and the second engagement part are further configured to:
receive the fiber device in a particular orientation to cause the first engagement part to contact the first surface of the fiber device and the second engagement part to contact the second surface of the fiber device, and
hold the fiber device in a particular position and in the particular orientation.

2. The structural component of claim 1, wherein the first engagement part and the second engagement part are further configured to:
enable, based on receiving the fiber device and holding the fiber device in the particular position and the particular orientation, coupling of a first connector of the fiber device and a second connector of the adapter component of the fiber inspection device.

3. The structural component of claim 2, wherein:
the particular orientation of the fiber device enables the first connector of the fiber device to align with the second connector of the adapter component of the fiber inspection device; and
the particular position of the fiber device enables the first connector of the fiber device to contact the second connector of the adapter component of the fiber inspection device.

4. The structural component of claim 1, wherein the mounting element includes a mounting feature that is configured to at least partially surround a portion of the adapter component of the fiber inspection device.

5. The structural component of claim 4, wherein the mounting element includes one or more stability parts configured to secure the mounting feature in a position that at least partially surrounds the portion of the adapter component of the fiber inspection device.

6. The structural component of claim 1, wherein the structural component further comprises:
a third engagement part of the mounting element that is configured to contact a third surface of the fiber device.

7. The structural component of claim 1, wherein the mounting element, the first holding element, and the second holding element are a monolithic component.

8. The structural component of claim 1, wherein the mounting element, the first holding element, and the second holding element define a holding volume of the structural component, and
wherein the first engagement part and the second engagement part are further configured to hold the fiber device in the particular position and in the particular orientation to cause a portion of the fiber device to be located within the holding volume of the structural component.

9. A fiber inspection device, comprising:
an adapter component; and
a structural component that includes:
a mounting element that mounts the structural component on the adapter component;
a first holding element and a second holding element connected to the mounting element;
a first engagement part positioned on the first holding element that is configured to contact a first surface of a fiber device; and
a second engagement part positioned on the second holding element that is configured to contact a second surface of the fiber device, wherein:
the first engagement part and the second engagement part are further configured to:
receive the fiber device in a particular orientation to cause the first engagement part to contact the first surface of the fiber device and the second engagement part to contact the second surface of the fiber device, and
hold the fiber device in a particular position and in the particular orientation.

10. The fiber inspection device of claim 9, wherein the first engagement part and the second engagement part are further configured to:
enable coupling of a first connector of the fiber device and a second connector of the adapter component.

11. The fiber inspection device of claim 9, wherein:
the particular orientation of the fiber device enables a first connector of the fiber device to align with a second connector of the adapter component; and
the particular position of the fiber device enables the first connector of the fiber device to contact the second connector of the adapter component.

12. The fiber inspection device of claim 9, wherein the mounting element includes a mounting feature that at least partially surrounds a portion of the adapter component.

13. The fiber inspection device of claim 9, wherein the mounting element includes one or more stability parts that secure a mounting feature of the mounting element in a position that at least partially surrounds a portion of the adapter component.

14. The fiber inspection device of claim 9, wherein the structural component further includes:
a third engagement part of the mounting element that is configured to contact a third surface of the fiber device.

15. The fiber inspection device of claim 9, wherein the mounting element, the first holding element, and the second holding element are a monolithic component.

16. A structural component, comprising:
a first engagement part of a first holding element that is configured to contact a first surface of a fiber device; and
a second engagement part of a second holding element that is configured to contact a second surface of the fiber device, wherein:
the first engagement part and the second engagement part are further configured to:
receive the fiber device in a particular orientation to cause the first engagement part to contact the first surface of the fiber device and the second engagement part to contact the second surface of the fiber device, and
hold the fiber device in a particular position and in the particular orientation.

17. The structural component of claim 16, wherein the first engagement part and the second engagement part are further configured to:
enable coupling of a first connector of the fiber device and a second connector of an adapter component.

18. The structural component of claim 16, wherein:
the particular orientation of the fiber device enables a first connector of the fiber device to align with a second connector of an adapter component; and
the particular position of the fiber device enables the first connector of the fiber device to contact the second connector of the adapter component.

19. The structural component of claim 16, wherein the structural component further comprises a mounting element connected to the first holding element and the second holding element, and
wherein the mounting element includes a mounting feature that is configured to at least partially surround a portion of an adapter component.

20. The structural component of claim 16, wherein the structural component further comprises:
a third engagement part that is configured to contact a third surface of the fiber device.
